(19) United States
(12) Patent Application Publication
(10) Pub. No.: US 2013/0120365 A1
(43) Pub. Date: May 16, 2013

(54) CONTENT PLAYBACK APPARATUS AND METHOD FOR PROVIDING INTERACTIVE AUGMENTED SPACE

(71) Applicants: Jun-Sup Lee, Daejeon (KR); Jae-Sang Yoo, Daejeon (KR); Hyung-Keun Jee, Daejeon (KR); Seok-Bin Kang, Daejeon (KR); Jun-Suk Lee, Daejeon (KR)

(72) Inventors: Jun-Sup Lee, Daejeon (KR); Jae-Sang Yoo, Daejeon (KR); Hyung-Keun Jee, Daejeon (KR); Seok-Bin Kang, Daejeon (KR); Jun-Suk Lee, Daejeon (KR)

(73) Assignee: Electronics and Telecommunications Research Institute, Daejeon (KR)

(21) Appl. No.: 13/612,711

(22) Filed: Sep. 12, 2012

(30) Foreign Application Priority Data
Nov. 14, 2011 (KR) 10-2011-0117987

(51) Int. Cl. G06T 15/00

(52) U.S. Cl. 345/419

(57) ABSTRACT

Disclosed herein is a content playback apparatus and method for providing an interactive augmented space. The content playback apparatus includes an augmented space recognition unit and an interaction processing unit. The augmented space recognition unit reconfigures a real space into a virtual space based on one depth image extracted from the real space, matching one or more primitive objects to the virtual space, and projects one or more virtual 3D objects, mapped to the primitive objects and combined with the reconfigured virtual space, onto the real space. The interaction processing unit recognizes one or more gesture interactions of a user related to the virtual 3D objects projected onto the real space and projects the virtual 3D objects onto the real space by incorporating deformations of the virtual 3D objects resulting from the recognized gesture interactions.

### CROSS-REFERENCE TO RELATED APPLICATION

This application claims the benefit of Korean Patent Application No. 10-2011-0117987, filed on Nov. 14, 2011, which is hereby incorporated by reference in its entirety into this application.

### BACKGROUND OF THE INVENTION

1. Technical Field

The present invention relates generally to a content playback apparatus and method for providing an interactive augmented space, which are capable of displaying back a user space and supporting direct three-dimensional (3D) touch interaction with a user and, more particularly, to a content playback apparatus and method for providing an interactive augmented space, which are capable of providing direct interaction with a user by providing augmented space content, such as 3D content, audio, video and an image, which is directly projected onto an irregular environment such as a common user space.

2. Description of the Related Art

Augmented reality and augmented virtuality are two types of mixed realities, and are techniques that combine a real space with a virtual space. Augmented reality and augmented virtuality are techniques that naturally combine virtual objects with a real image or a real image with a virtual space and provide mutual interaction.

Conventional mixed reality techniques, such as augmented reality and augmented virtuality, deal with matching a single image with 3D objects. In augmented reality, 3D geometric coordinates are recognized from a single input image using a special image identifier, such as an optical marker, and 3D objects are combined with the recognized 3D geometric coordinates. In contrast, in augmented virtuality, a 3D virtual space is generated based on 3D geometric information that is obtained from a single image or that was previously defined, a user is extracted from an input real image, and the user is matched and combined with the generated 3D virtual space.

A conventional augmented reality provision system commonly extracts image information, including marker information, from an image captured by a web camera or a camcorder, and then approximates information about the postures of objects. The conventional augmented reality provision system provides a mixed reality experience to a learner by matching multimedia content, such as sound, two-dimensional (2D)/3D virtual objects and a moving image, with an input real image using estimated posture information and then showing the matched multimedia content to the learner. Accordingly, the conventional augmented reality provision system may help a user have an improved experiential effect in addition to the feelings of immersion and realism.

The conventional augmented reality provision system includes a vision-based augmented reality provision system, such as a marker-based augmented reality system or a markerless augmented reality system. That is, the conventional augmented reality provision system selectively uses the marker-based augmented reality system using markers or the markerless augmented reality system using a natural image in which artificial markers are not included in an input image in order to match a real space with a virtual space.

Other types of augmented reality provision systems include a position-based augmented reality provision system using position information, such as a Global Positioning System (GPS), included in a user mobile terminal, and a sensor-based augmented reality provision system using a gyro sensor, an acceleration sensor, or a compass sensor included in a user terminal.

In all of the vision-based augmented reality provision system, the location-based augmented reality provision system, and the sensor-based augmented reality provision system, virtual content is matched with a real space in an additional display device, such as a user screen (or display), a monitor, or a screen. That is, the conventional augmented reality provision system is problematic in that virtual content is not matched with a user space so that they can directly interact with each other because augmented reality is provided in the form of one window and thus a user's real space is different from a space in which the augmented reality is reproduced.

Another type of an augmented reality providing technique includes a Media Facade method or a projection mapping method. The Media Facade method and the projection mapping method are problematic in that user interaction is limited and projection onto a dynamic space is impossible because projection is performed on a user's limited real space or a simple large-sized screen, although content is incorporated into the user's real space by projecting the content using a projector.

### SUMMARY OF THE INVENTION

Accordingly, the present invention has been made keeping in mind the above problems occurring in the prior art, and an object of the present invention is to provide a content playback apparatus and method for providing an interactive augmented space, which are capable of mapping content, matched with a number of dynamic objects placed in the real space of a user, to a number of the dynamic objects by directly projecting the content onto the dynamic objects, and allowing content to undergo deformation and react in response to user interaction.

In order to accomplish the above objects, the present invention provides a content playback apparatus for providing an interactive augmented space, including an augmented space recognition unit for reconfiguring a real space into a virtual space based on one depth image extracted from the real space, matching one or more primitive objects to the virtual space, and projecting one or more virtual 3D objects, mapped to the primitive objects and combined with the reconfigured virtual space, onto the real space; and an interaction processing unit for recognizing one or more gesture interactions of a user related to the virtual 3D objects projected onto the real space and projecting the virtual 3D objects onto the real space by incorporating deformations of the virtual 3D objects resulting from the recognized gesture interactions.

The augmented space recognition unit may include an augmented space display multi-connection module for merging a plurality of depth images, extracted by a plurality of cameras installed in the real space, into the depth image.

The augmented space recognition unit may include a real space 3D recognition module for reconfiguring the depth image of the real space into the virtual space in a form of 3D polygons or point clouds.

The augmented space recognition unit may include a virtual space matching module for matching the primitive objects, included in content, to the reconfigured virtual space.

The augmented space recognition unit may include an augmented space content projection module for projecting the virtual 3D objects onto the real space.

The interaction processing unit may include a gesture interaction recognition module for generating interaction point information and gesture information by recognizing interaction points and one or more gestures of the user, placed in the real space, using multi-user information identified using the depth image of the real space.

The interaction processing unit may include an interactive augmented stage configuration module for reconfiguring the virtual 3D objects projected onto the real space by incorporating one or more user interactions based on interaction point information and gesture information generated by recognizing the user placed in the real space.

The interaction processing unit may include a user recognition/tracking module for generating multi-user information by identifying the user in the depth image of the real space; and an interactive augmented stage configuration module for generating real space coordinate information and one or more gesture events of interaction points based on user gesture information and interaction point information.

The content playback apparatus may further include an augmented space reconstruction unit for combining the virtual 3D objects with the primitive objects matched with the reconfigured virtual space and rendering the virtual 3D content selected from results combined with the reconfigured virtual space and mapped to the reconfigured virtual space.

The augmented space reconstruction unit may include a content processing module for loading content in which a plurality of the primitive objects and a plurality of the virtual 3D objects have been paired and allocating the virtual 3D objects, included in the loaded content, to the primitive objects matched with the reconfigured virtual space.

The augmented space reconstruction unit may include a 3D new configuration reconstruction module for mapping the virtual 3D objects, included in the content, to the primitive objects matched with the reconfigured virtual space.

The augmented space reconstruction unit may include an augmented content playback module for combining the reconfigured virtual space, to which the virtual 3D objects have been mapped, with the real space by matching the reconfigured virtual space to the real space; and a 3D rendering module for rendering virtual 3D content which is obtained by subtracting the reconfigured virtual space from the results combined with the real space using the augmented content playback module.

In order to accomplish the above objects, the present invention provides a content playback method for providing an interactive augmented space, including loading, by an augmented space reconstruction unit, content including one or more primitive objects and one or more virtual 3D objects; matching, by an augmented space recognition unit, the primitive objects, included in the content, to a virtual space reconfigured based on one depth image of a real space; mapping, by the augmented space recognition unit, the virtual 3D objects, included in the content, to the primitive objects matched with the reconfigured virtual space; and projecting, by the augmented space recognition unit, the mapped virtual 3D objects onto the real space.

The matching may include merging a plurality of depth images extracting from the real space; reconfiguring the real space into the virtual space using the depth image; detecting areas where the primitive objects included in the content will be placed in the reconfigured virtual space; and matching the primitive objects to the detected areas.

The reconfiguring may include reconfiguring the real space into the virtual space in a form of 3D polygons or point clouds.

The mapping may include allocating the virtual 3D objects, included in the content, to the primitive objects matched with the reconfigured virtual space; and mapping the allocated virtual 3D objects to the reconfigured virtual space.

The projecting may include combining the virtual 3D objects with the reconfigured virtual space; rendering the combined virtual 3D objects; and projecting the rendered virtual 3D objects onto the real space.

The rendering may include rendering only virtual 3D content selected from among the primitive objects and the virtual 3D content combined with the reconfigured virtual space.

The content playback method may further include incorporating, by an interaction processing unit, one or more user interactions in the real space into the projected virtual 3D objects.

The incorporating may include identifying multi-user information in the real space; recognizing one or more user gestures and interaction points based on the identified multi-user information; generating one or more gesture events by matching the recognized user gesture and interaction points with the reconfigured virtual space via topological space matching; and projecting the virtual 3D objects onto the real space by incorporating deformations of the virtual 3D objects based on the generated gesture events into the real space.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are diagrams illustrating a content playback apparatus for providing an interactive augmented space according to an embodiment of the present invention;

FIG. 3 is a diagram illustrating the augmented space reconstruction unit of FIG. 1;

FIG. 4 is a diagram illustrating the augmented space recognition unit of FIG. 1;

FIG. 5 is a diagram illustrating the interaction processing unit of FIG. 1;

FIG. 6 is a flowchart illustrating a content playback method for providing an interactive augmented space according to an embodiment of the present invention;

FIGS. 7 to 9 are diagrams illustrating the step of matching primitive objects, which is shown in FIG. 6;

FIGS. 10 and 11 are diagrams illustrating the step of mapping virtual 3D objects, which is shown in FIG. 6;

FIGS. 12 and 13 are diagrams illustrating the step of projecting onto a real space, which is shown in FIG. 6;

FIGS. 14 to 16 are diagrams illustrating the step of incorporating user interaction, which is shown in FIG. 6; and

FIGS. 17 to 19 are diagrams illustrating examples to which the content playback apparatus and method for providing an interactive augmented space according to the embodiments of the present invention have been applied.

### DESCRIPTION OF THE PREFERRED EMBODIMENTS

In order to describe the present invention in detail so that those skilled in the art can easily practice the technical spirit of the present invention, embodiments of the present invention will be described with reference to the accompanying drawings. It should be noted that the same reference numerals are used to designate the same or similar components throughout the drawings. In the following description, detailed descriptions of well-known functions or configurations which would unnecessarily obscure the gist of the present invention will be omitted.

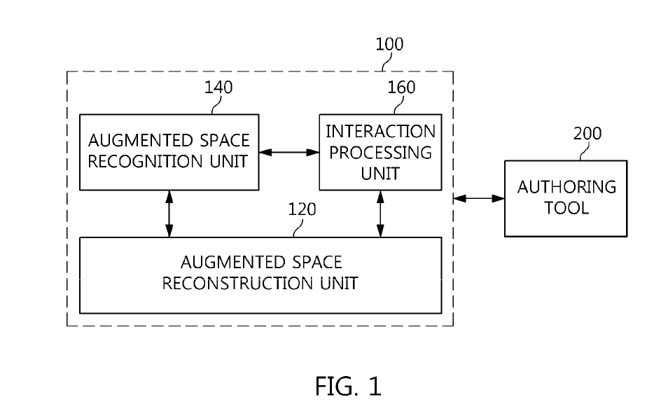

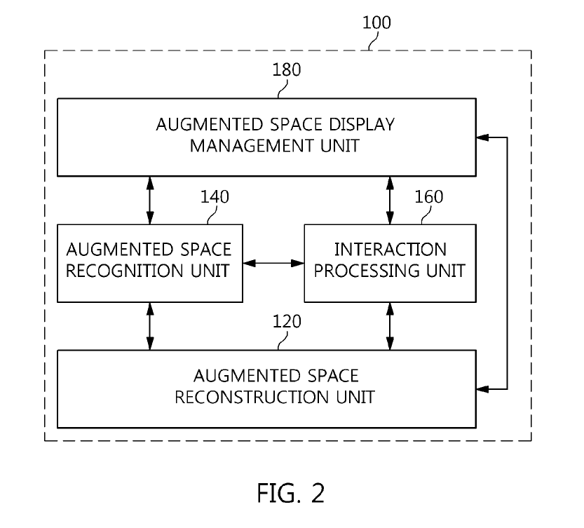

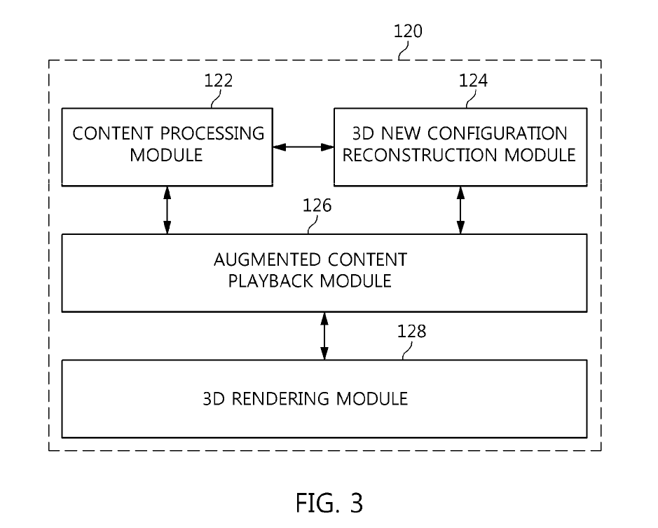

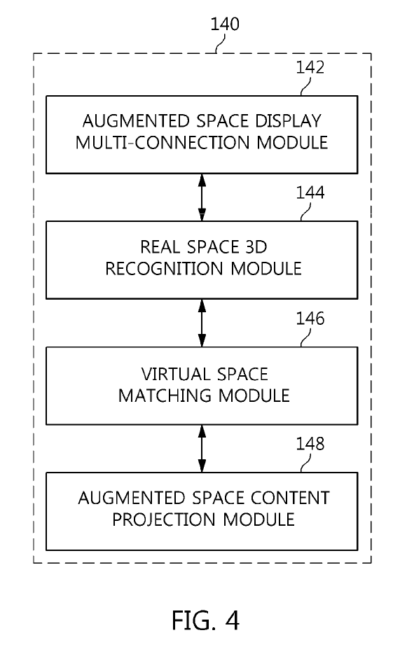

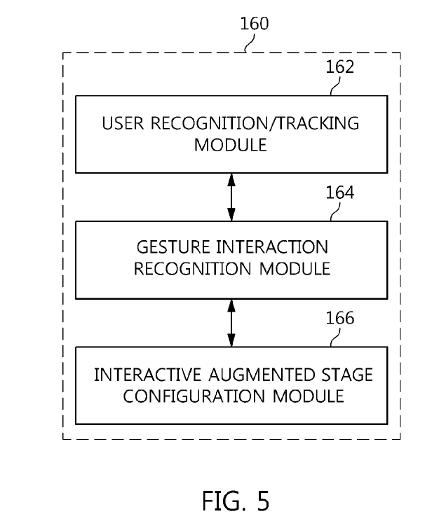

A content playback apparatus for providing an interactive augmented space according to an embodiment of the present invention will now be described in detail with reference to the accompanying drawings. FIGS. 1 and 2 are diagrams illustrating the content playback apparatus for providing an interactive augmented space according to the embodiment of the present invention, FIG. 3 is a diagram illustrating the augmented space reconstruction unit of FIG. 1, FIG. 4 is a diagram illustrating the augmented space recognition unit of FIG. 1, and FIG. 5 is a diagram illustrating the interaction processing unit of FIG. 1.

As shown in FIG. 1, the content playback apparatus 100 for providing an interactive augmented space provides an interactive augmented space to a user by playing back 3D content, created by an authoring tool 200, in such a way as to project the 3D content onto the real space of the user. For this purpose, the content playback apparatus 100 for providing an interactive augmented space includes an augmented space reconstruction unit 120, an augmented space recognition unit 140, and an interaction processing unit 160. As shown in FIG. 2, the content playback apparatus 100 for providing an interactive augmented space may further include an augmented space display management unit 180 which remotely controls and synchronizes 3D content

The augmented space reconstruction unit 120 loads content, on the basis of which the locations where virtual objects are projected in the real space are detected, from the authoring tool 200. Here, the augmented space reconstruction unit 120 loads content in which a plurality of primitive objects and a plurality of virtual 3D objects have been paired. The augmented space reconstruction unit 120 allocates the virtual 3D objects to the primitive objects which have been matched with the 3D polygons (or point clouds) of the real space. The augmented space reconstruction unit 120 maps the allocated virtual 3D objects to the 3D polygons (or point clouds) of the real space. The augmented space reconstruction unit 120 combines the 3D polygons (or point clouds) of the real space, to which the virtual 3D objects have been mapped, with the real space by matching the 3D polygons with the real space. The augmented space reconstruction unit 120 renders the virtual 3D objects combined with the real space. For this purpose, the augmented space reconstruction unit 120 includes a content processing module 122, a 3D new configuration reconstruction module 124, an augmented content playback module 126, and a 3D rendering module 128, as shown in FIG. 3.

The content processing module 122 loads content created by the authoring tool 200 (e.g., an augmented space display authoring tool or other 3D authoring tools). Here, the content which is created by the authoring tool 200 is created in such a way that virtual 3D objects and primitive objects (e.g., a regular hexahedron, a cone, a cylinder, a regular tetrahedron, a sphere, a floor, and a wall) onto which the virtual 3D objects may be projected are paired. The content includes information regarding virtual 3D objects projected onto an augmented space, scripts defining reactions to user interactions, and multimedia content including sounds for other event effects and moving images.

The content processing module 122 allocates the virtual 3D objects to the primitive objects, matched with the 3D polygons (or point clouds) of the real space, using the augmented space recognition unit 140 (i.e., a virtual space matching module 146 which will be described later). Here, the content processing module 122 allocates the virtual 3D objects to the primitive objects matched with the 3D polygons (or point clouds) of the real space based on the pairing of the plurality of primitive objects and the plurality of virtual 3D objects included in the loaded content. The content processing module 122 sends the virtual 3D objects, allocated to the primitive objects, to the 3D new configuration reconstruction module 124.

The 3D new configuration reconstruction module 124 maps the virtual 3D objects, received from the content processing module 122, to the 3D polygons (or point clouds) of the real space. That is, the 3D new configuration reconstruction module 124 maps the allocated virtual 3D objects to the respective primitive objects matched with the 3D polygons (or point clouds) of the real space. Accordingly, the virtual 3D objects (e.g., a water jar, a whole chicken, bread, a wine glass, and an apple) are matched and mapped to the primitive objects which have been matched with a floor, walls, pillars and a table in the real space of the user.

The augmented content playback module 126 combines the 3D polygons (or point clouds) of the real space, to which the virtual 3D objects have been mapped, with the real space by matching the 3D polygons (or point clouds) of the real space with the real space. Here, in order to precisely match the virtual 3D objects to the real space, the augmented content playback module 126 uses intrinsic parameters including information, such as information about the angles of view of projectors which have performed projection and depth cams or stereos cam which have recognized the real space, and extrinsic parameters, including information about the locations of the projectors and cameras in the real space.

The 3D rendering module 128 renders the results, combined with the real space, using the augmented content playback module 126. That is, the 3D rendering module 128 renders the virtual 3D objects (e.g., a water jar, a whole chicken, bread, a wine glass, and an apple) mapped to the real space, other than the reconstructed 3D polygons (or point clouds) of the reconfigured real space.

The augmented space recognition unit 140 recognizes the real space where the table, the walls, the floor, and the pillars are placed in a 3D manner, and performs tracking. The augmented space recognition unit 140 deals with a variety of dynamic environments by matching a virtual space and virtual 3D objects, used in content authoring, to the real space and the real objects. The augmented space recognition unit 140 uses a performer space itself as a tangible display by augmenting a 3D image matched with the real space. The augmented space recognition unit 140 shares one augmented 3D space by supporting a plurality of space displays depending on the size of the installation space. For this purpose, the augmented space recognition unit 140 reconfigures the real space within the virtual space using a plurality of depth images of the real space of the user. Here, the augmented space recognition unit 140 reconfigures the real environment in the form of 3D polygons or point clouds. The augmented space recognition unit 140 matches the primitive objects, included in the content, to the 3D polygons (or point clouds) of the real space. The augmented space recognition unit 140 matches the primitive objects, matched with the 3D polygons (or point clouds) of the real space, to the virtual 3D objects. For this purpose, the augmented space recognition unit 140 includes an augmented space display multi-connection module 142, a real space 3D recognition module 144, the virtual space matching module 146, and augmented space content projection module 148, as shown in FIG. 4.

The augmented space display multi-connection module 142 merges a plurality of depth images of the real space of the user into one depth image. The augmented space display multi-connection module 142 sends the resulting depth image to the real space 3D recognition module 144. Here, the augmented space display multi-connection module 142 receives a plurality of depth images extracted by a plurality of cameras installed in the real space of the user. Here, the plurality of cameras installed in the real space of the user includes depth cams, stereo cameras or the like.

The real space 3D recognition module 144 reconfigures the real environment of the user within the virtual space using the depth image received from the augmented space display multi-connection module 142. Here, the real space 3D recognition module 144 reconfigures the real environment of the user in the form of 3D polygons or point clouds within the virtual space. The real space 3D recognition module 144 sends the reconfigured 3D polygons or point clouds to the virtual space matching module 146.

The virtual space matching module 146 detects areas where the primitive objects defined in the loaded content will be placed using the reconfigured real space 3D polygons. That is, the virtual space matching module 146 separates and identifies areas, corresponding to the plurality of primitive objects included in the loaded content, from the 3D polygons (or point clouds) of the real space using a geometric matching scheme.

The virtual space matching module 146 matches the plurality of primitive objects to the 3D polygons (or point clouds) of the real space. That is, the virtual space matching module 146 matches the primitive objects, included in the loaded content, to the areas detected using the 3D polygons (or point clouds) of the real space. In this case, the virtual space matching module 146 matches the primitive objects to the areas separated and identified based on the plurality of primitive objects using the 3D polygons (or point clouds) of the real space. That is, the virtual space matching module 146 matches the primitive objects, included in the content, to structures, such as the floor, the walls, the pillars, and the table, which are present in the real space of the user.

The augmented space content projection module 148 projects the virtual 3D objects, rendered by the augmented space reconstruction unit 120 (i.e., the 3D rendering module 128), onto the real space. For this purpose, the augmented space content projection module 148 transfers the rendered virtual 3D objects to a plurality of projectors installed along with depth cams or stereo cams. The plurality of projectors projects the rendered virtual 3D objects onto the real space. Accordingly, the virtual 3D objects (e.g., a water jar, a whole chicken, bread, a wine glass, and an apple) are projected onto the floor, the walls, the pillars and the table in the real space.

The interaction processing unit 160 incorporates the user's gesture interactions into the virtual 3D objects projected onto the real space. That is, the interaction processing unit 160 projects the virtual 3D objects onto the real space by incorporating the deformation of the virtual 3D objects in accordance with scripts corresponding to the gesture interactions detected in the real space. For this purpose, the interaction processing unit 160 includes a user recognition/tracking module, a gesture interaction recognition module 164, and an interactive augmented stage configuration module 166, as shown in FIG. 5.

The user recognition/tracking module 162 receives a depth image (i.e., a depth information image) from the depth cams or the stereo cams installed in the real space, and identifies a multi-user in the depth image. The user recognition/tracking module 162 sends the identified multi-user information to the gesture interaction recognition module 164.

The gesture interaction recognition module 164 recognizes user interaction points (e.g., the hand, a foot, and the head) based on the multi-user information received from the user recognition/tracking module 162. The gesture interaction recognition module 164 recognizes user gestures (e.g., a touch, a drag, raising a hand, and walking) based on the multi-use information. The gesture interaction recognition module 164 sends the recognized user interaction point information and the gesture information to the interactive augmented stage configuration module 166.

The interactive augmented stage configuration module 166 matches the user gesture information and the interaction point information, received from the gesture interaction recognition module 164, to the reconfigured 3D polygons of the real space via topological space matching. Accordingly, the interactive augmented stage configuration module 166 may generate one or more gesture events in a state information form along with real space coordinate information about the user interaction points.

The interactive augmented stage configuration module 166 reconfigures the virtual 3D objects based on the gesture events, such as a touch, a drag, and a click, according to the scripts defining interactions with the virtual 3D objects defined in the content. Accordingly, the augmented space content of the user is deformed by incorporating the deformation of the virtual 3D objects based on the interactions of the user, and the deformed augmented space content is projected onto the real space.

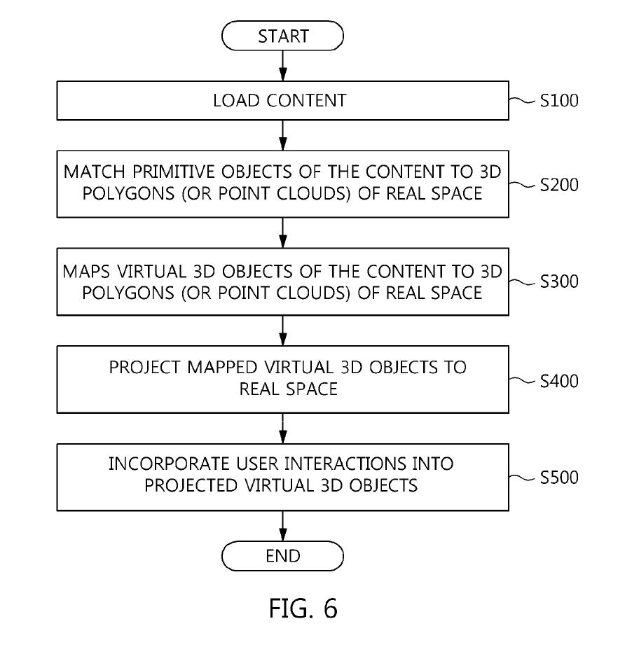

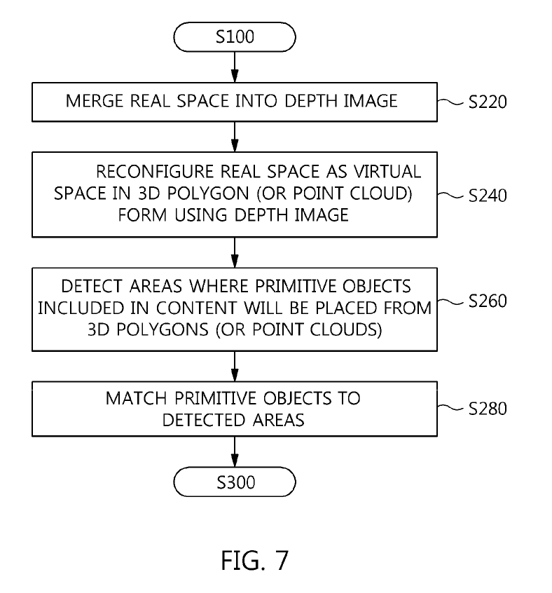

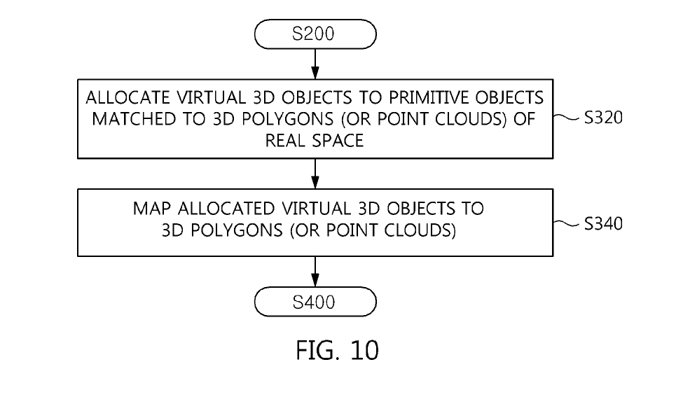

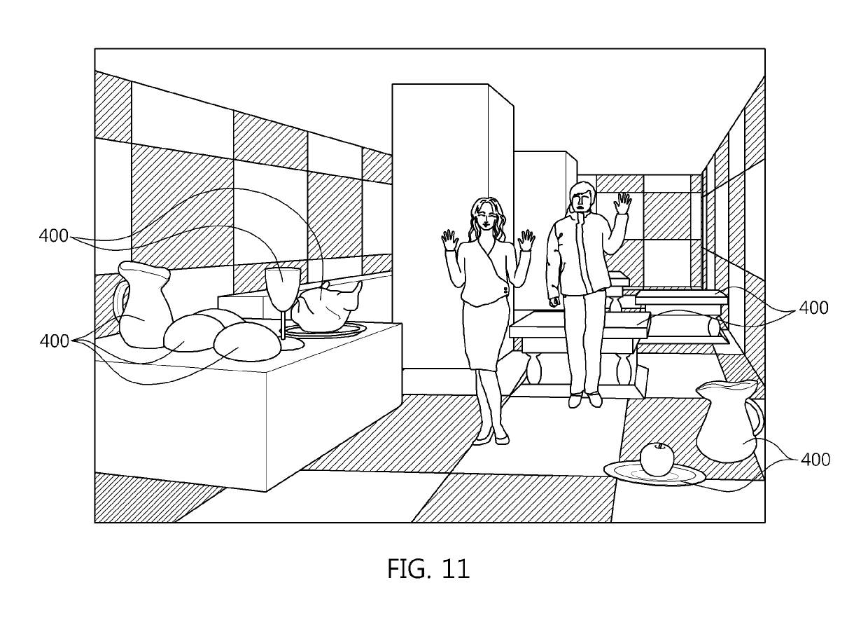

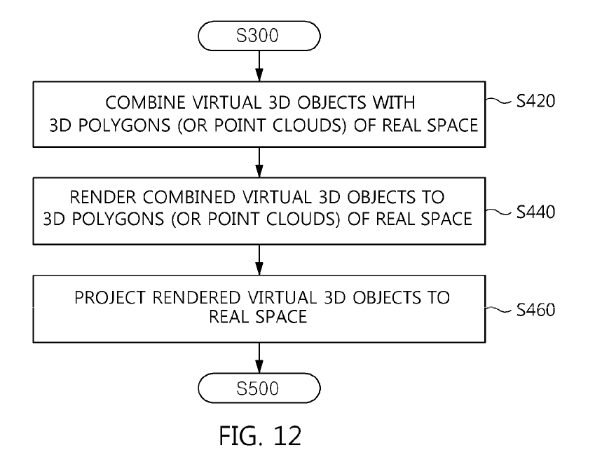

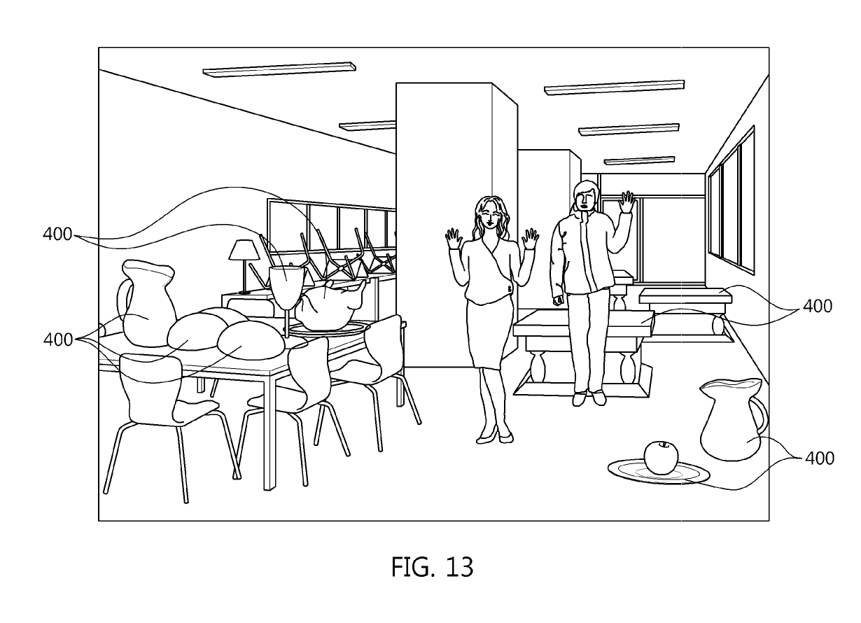

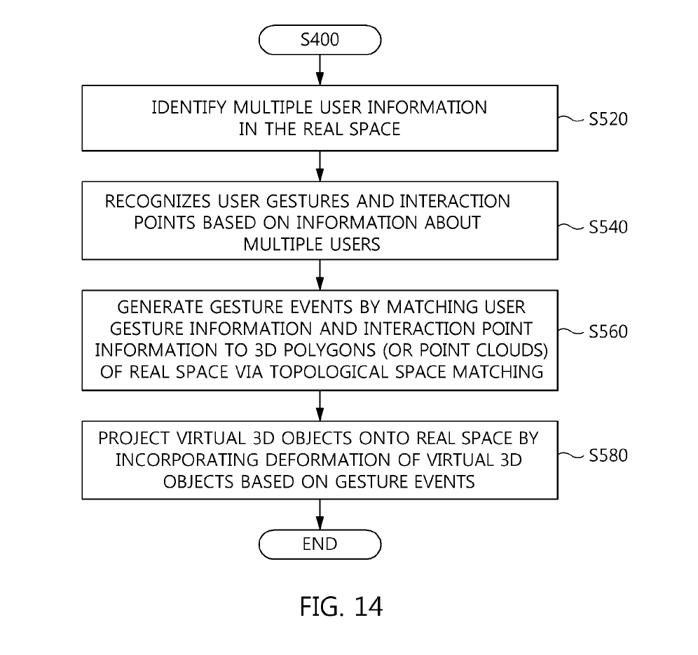

A content playback method for providing an interactive augmented space according to an embodiment of the present invention will now be described in detail with reference to the accompanying drawings. FIG. 6 is a flowchart illustrating a content playback method for providing an interactive augmented space according to the embodiment of the present invention, FIGS. 7 to 9 are diagrams illustrating the step of matching the primitive objects 300, which is shown in FIG. 6, FIGS. 10 and 11 are diagrams illustrating the step of mapping the virtual 3D objects 400, which is shown in FIG. 6, FIGS. 12 and 13 are diagrams illustrating the step of projecting onto a real space, which is shown in FIG. 6, and FIGS. 14 to 16 are diagrams illustrating the step of incorporating user interaction, which is shown in FIG. 6.

First, the augmented space reconstruction unit 120 loads content, on the basis of which the locations where virtual objects are projected in a real space are detected, from the authoring tool 200 at step S100. That is, the content processing module 122 of the augmented space reconstruction unit 120 loads content created by the authoring tool 200. Here, the content which is created by the authoring tool 200 is created in such a way that virtual 3D objects 400 and primitive objects 300 (e.g., a regular hexahedron, a cone, a cylinder, a regular tetrahedron, a sphere, a floor, and a wall) onto which the virtual 3D objects 400 may be projected are paired. The content includes information regarding the virtual 3D objects projected onto an augmented space, scripts defining reactions to user interactions, and multimedia content including sounds for other event effects and moving images.

The augmented space recognition unit 140 matches the primitive objects 300, including the loaded content, to the 3D polygons (or point clouds) of the real space at step S200.

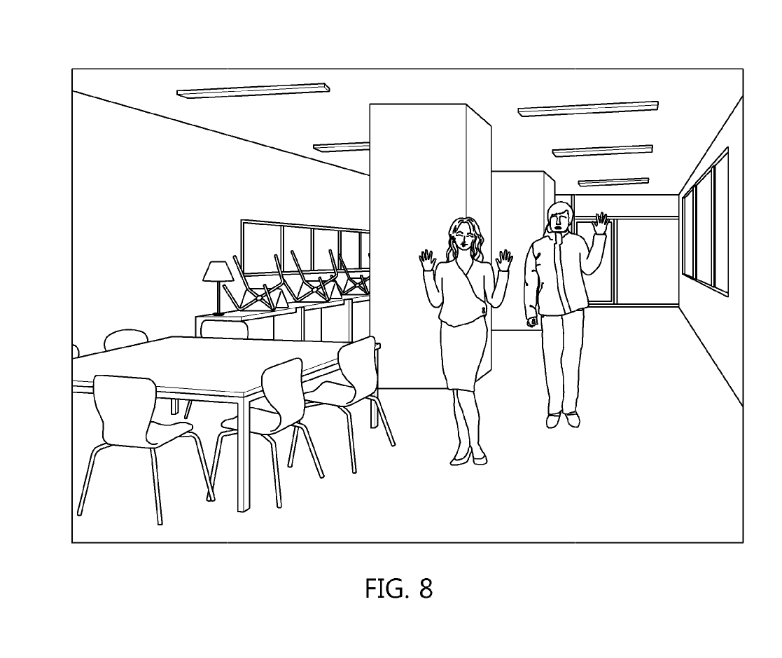

More specifically, the augmented space display multi-connection module 142 of the augmented space recognition unit 140 merges a plurality of depth images of the real space of the user into one depth image at step S220. Here, the augmented space display multi-connection module 142 receives the plurality of depth images extracted by a plurality of cameras 600 installed in the real space of the user. That is, as shown in FIG. 8, the augmented space display multi-connection module 142 converts the depth images of the real space, captured by depth cams or stereo cameras installed in the real space of the user, into the one depth image by merging the depth images of the real space. The augmented space display multi-connection module 142 sends the merged depth image to the real space 3D recognition module 144.

The real space 3D recognition module 144 reconfigures a real environment of the user within the virtual space using the depth images received from the augmented space display multi-connection module 142. Here, the real space 3D recognition module 144 reconfigures the real environment of the user within the virtual space in the form of 3D polygons or point clouds at step S240. The real space 3D recognition module 144 sends the reconfigured 3D polygons or point clouds to the virtual space matching module 146.

The virtual space matching module 146 detects areas where the primitive objects 300 defined in the loaded content will be placed using the 3D polygon of the reconfigured real space at step S260. That is, the virtual space matching module 146 separates and identifies areas, corresponding to the plurality of primitive objects 300 included in the loaded content, from the 3D polygons (or point clouds) of the real space using a geometric matching scheme.

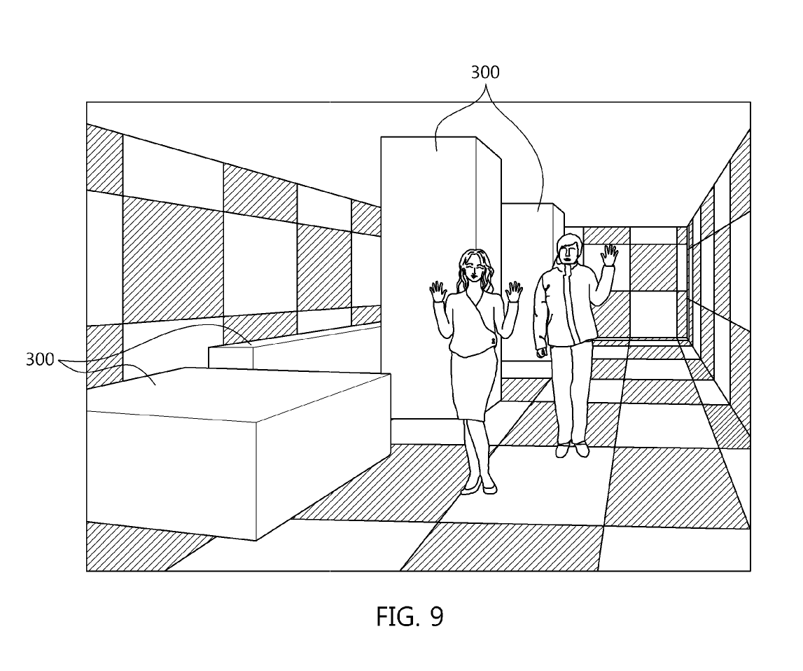

The virtual space matching module 146 matches the plurality of primitive objects 300 with the 3D polygons (or point clouds) of the real space at step S280. That is, as shown in FIG. 9, the virtual space matching module 146 matches the primitive objects 300, included in the loaded content, with the areas detected from the 3D polygons (or point clouds) of the real space. That is, the virtual space matching module 146 matches the primitive objects 300 with the areas separated and identified based on the plurality of primitive objects 300 using the 3D polygons (or point clouds) of the real space. The virtual space matching module 146 matches the primitive objects 300, included in the content, with structures, such as a floor, a wall, a pillar, and a table which exist in the real space of the user.

The augmented space reconstruction unit 120 maps the virtual 3D objects 400, included in the loaded content, to the 3D polygons (or point clouds) of the real space at step S300.

More specifically, the content processing module 122 allocates the virtual 3D objects 400 to the primitive objects 300 matched with the 3D polygons (or point clouds) of the real space in the virtual space matching module 146 at step S320. Here, the content processing module 122 allocates the virtual 3D objects 400, matched with the 3D polygons (or point clouds) of the real space, to the primitive objects based on the pairing of the plurality of primitive objects 300 and the plurality of virtual 3D objects 400 included in the loaded content. The content processing module 122 sends the virtual 3D objects 400, allocated to the primitive objects, to the 3D new configuration reconstruction module 124.

The 3D new configuration reconstruction module 124 maps the virtual 3D objects 400, received from the content processing module 122, to the 3D polygons (or point clouds) of the real space at step S340. That is, the 3D new configuration reconstruction module 124 maps the virtual 3D objects 400, allocated to the respective primitive objects 300, to the plurality of primitive objects 300 matched with the 3D polygons (or point clouds) of the real space. Accordingly, as shown in FIG. 11, the virtual 3D objects 400 (e.g., a water jar, a whole chicken, bread, a wine glass, and an apple) are matched and mapped to the primitive objects 300 matched with the floor, the walls, the pillars and the table in the real space of the user.

The augmented space reconstruction unit 120 and the augmented space recognition unit 140 project the mapped virtual 3D objects 400 onto the real space at step S400.

More specifically, the augmented content playback module 126 of the augmented space reconstruction unit 120 combines the 3D polygons (or point clouds) of the real space, to which the virtual 3D objects 400 have been mapped, with the real space by matching the 3D polygons (or point clouds) of the real space with the real space at step S420. Here, in order to precisely match the virtual 3D objects 400 with the real space, the augmented content playback module 126 uses intrinsic parameters including information, such as information about the angles of view of projectors 700 which have performed projection and the depth cams or stereo cams which have recognized the real space, and extrinsic parameters, including information about the locations of the projectors 700 and the cameras 600 in the real space.

The 3D rendering module 128 of the augmented space reconstruction unit 120 renders the results, combined with the real space, using the augmented content playback module 126. That is, the 3D rendering module 128 renders the virtual 3D objects 400 mapped to the real space, other than the 3D polygons (or point clouds) of the reconfigured real space, at step S440.

The augmented space content projection module 148 of the augmented space recognition unit 140 projects the virtual 3D objects 400, rendered by the 3D rendering module 128, onto the real space at step S460. For this purpose, the augmented space content projection module 148 transfers the rendered virtual 3D objects 400 to the plurality of projectors 700 installed along with the depth cams or the stereo cams. The plurality of projectors 700 projects the rendered virtual 3D objects 400 onto the real space. Accordingly, as shown in FIG. 13, the virtual 3D objects 400 are projected onto the floor, the walls, the pillars and the table in the real space.

The interaction processing unit 160 incorporates user interactions into the projected virtual 3D objects 400 at step S500. That is, the interaction processing unit 160 projects the projected virtual 3D objects 400 onto the real space by incorporating the deformation of the virtual 3D objects 400 into the real space based on scripts corresponding to gesture interactions detected in the real space.

More specifically, the user recognition/tracking module 162 identifies multi-user information in the real space at step S520. That is, the user recognition/tracking module 162 receives depth images (i.e., depth information images) from the depth cams or the stereo cams installed in the real space, and identifies the multi-user from the received depth images. The user recognition/tracking module 162 sends the identified multi-user information to the gesture interaction recognition module 164.

The gesture interaction recognition module 164 recognizes user interaction points based on the multi-user information received from the user recognition/tracking module 162. The gesture interaction recognition module 164 recognizes user gestures based on the multi-user information at step S540. Here, the gesture interaction recognition module 164 recognizes interaction point information, such as the hand, a foot, and the head, and gesture information, such as a touch, a drag, raising a hand, and walking. The gesture interaction recognition module 164 sends the recognized user interaction point information and the recognized gesture information to the interactive augmented stage configuration module 166.

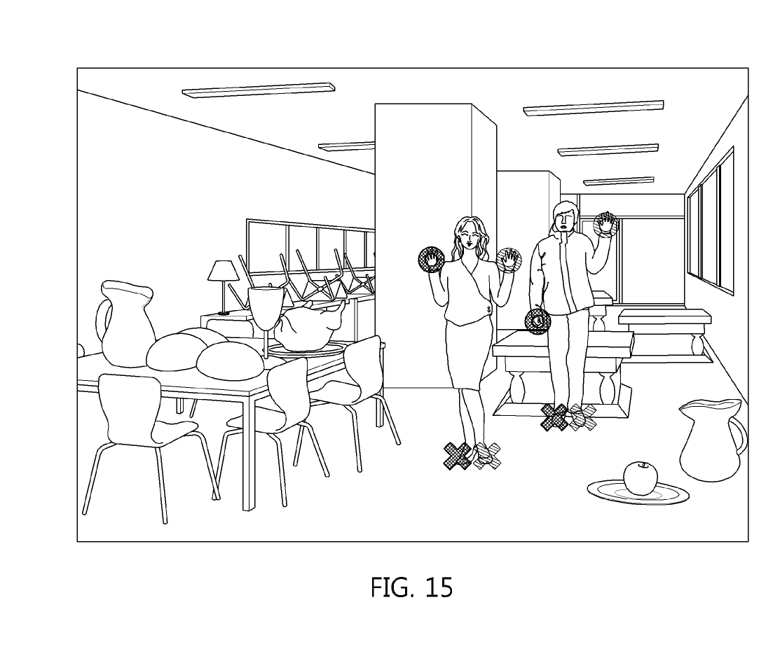

The interactive augmented stage configuration module 166 generates one or more gesture events by matching the user gesture information and interaction point information, received from the gesture interaction recognition module 164, with the 3D polygons (or point clouds) of the real space via topological space matching at step S560. That is, the interactive augmented stage configuration module 166 matches the user gesture information and interaction point information, received from the gesture interaction recognition module 164, to the reconfigured 3D polygons of the real space via topological space matching. Accordingly, as shown in FIG. 15, the interactive augmented stage configuration module 166 generates the gesture events in the form of state information along with real space coordinate information about the user interaction points.

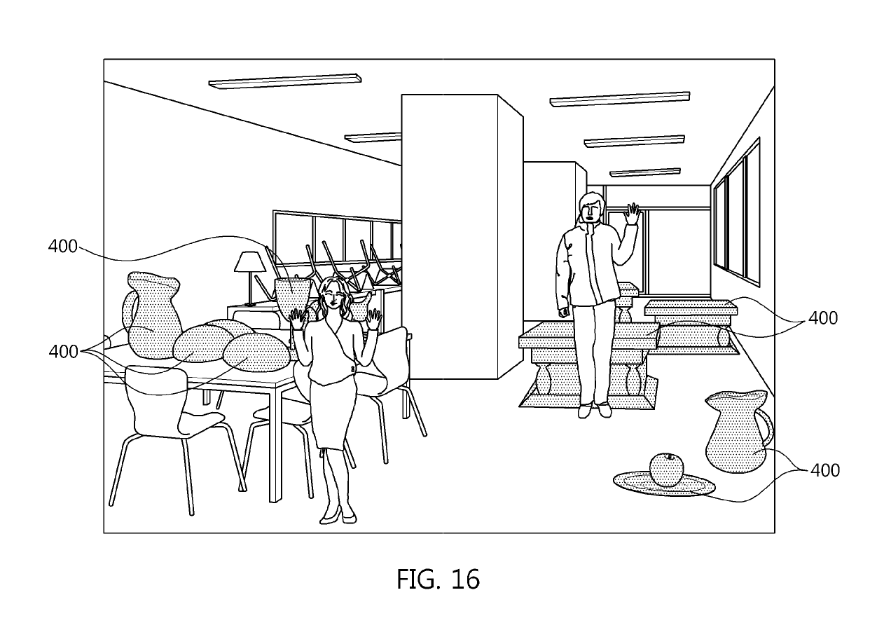

The interactive augmented stage configuration module 166 reconfigures the virtual 3D objects 400 based on the gesture events, such as touches, drags and clicks, according to scripts defining interactions with the virtual 3D objects 400 defined in the content, and projects the reconfigured virtual 3D objects 400 onto the real space at step S580. Accordingly, as shown in FIG. 16, the augmented space content of the user is deformed by incorporating the deformation of the virtual 3D objects 400 resulting from the user's interactions, and the deformed augmented space content is projected onto the real space.

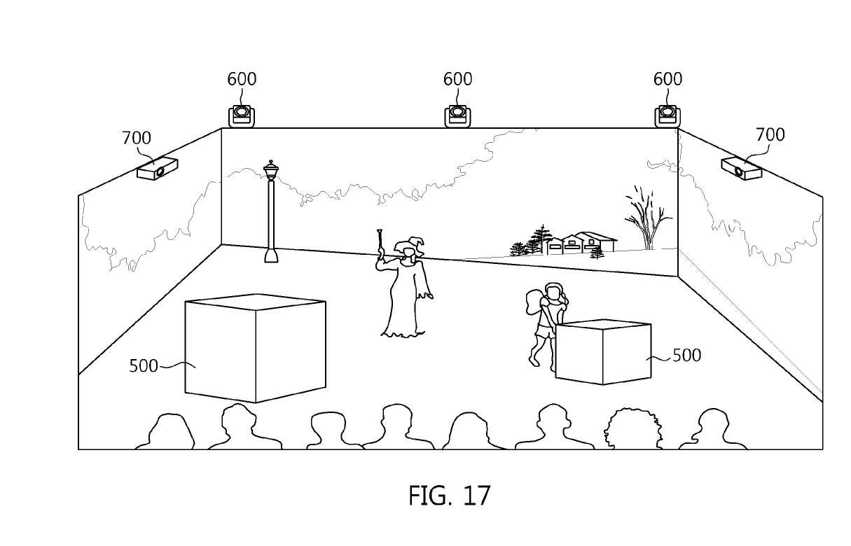

Examples to which the content playback apparatus 100 and method for providing an interactive augmented space according to the embodiments of the present invention have been applied will now be described in detail with reference to the accompanying drawings. FIGS. 17 to 19 are diagrams illustrating examples to which the content playback apparatus and method for providing an interactive augmented space according to the embodiments of the present invention are applied. FIGS. 17 to 19 are examples in which the content playback apparatus 100 and method for providing an interactive augmented space have been applied to a theater stage.

First, the projecting real space (i.e., the three walls and floor of FIG. 17) of the theater stage and real objects 500 (i.e., two hexahedra placed on the floor of FIG. 17) are recognized by the plurality of cameras 600 installed in the theater stage. Furthermore, two performers placed in the projecting real space are detected by the plurality of cameras 600.

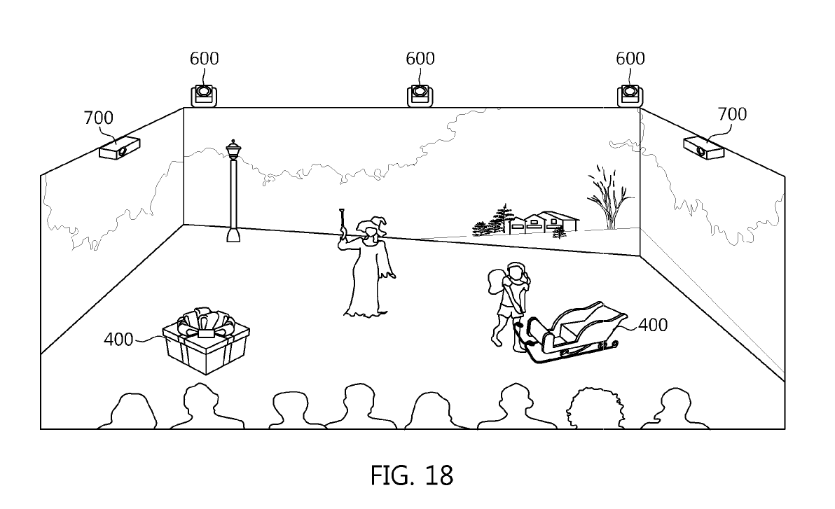

The plurality of projectors 700 installed in the theater stage directly project virtual 3D objects onto the real objects 500 placed in the real space. Accordingly, as shown in FIG. 18, the real objects 500 placed in the real space are displayed as a gift box and a sled, that is, the virtual 3D objects.

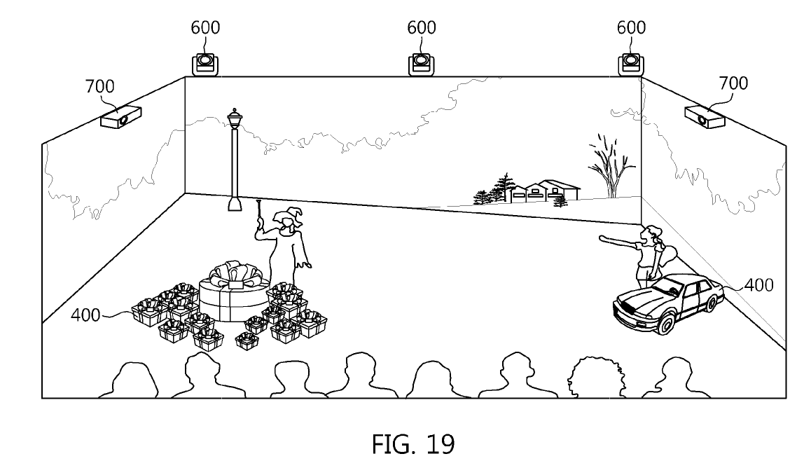

Other virtual 3D objects 400 are mapped to the virtual 3D objects 400, matched with the theater stage (i.e., a user space) and the real objects 500 and projected onto the real objects 500 using the projectors 700, in response to actions of the performers, such as a touch. Accordingly, interactions between the performers and the virtual 3D objects 400 are provided. That is, as shown in FIG. 19, when the performer touches the real object 500 onto which the virtual 3D object 400 has been projected, the number of gift boxes projected onto the real object 500 may be increased or the sled may be changed into a car by detecting the touch.

As described above, according to the present invention, the content playback apparatus and method for providing an interactive augmented space is advantageous in that they can provide a space interaction-centered content service which displays a real space and supports direct 3D touch interaction with a user, thereby enabling space interactive content which enables content to be directly displayed in a user space and supports interaction.

Furthermore, the content playback apparatus and method for providing an interactive augmented space can project interactive 3D content onto the existing space using interactive space display content, thereby increasing the feelings of immersion and experience in a variety of application services, education, edutainment, and public performances by.

Furthermore, the content playback apparatus and method for providing an interactive augmented space can provide interactive space role-play learning content, 3D space multi-room content, and interactive 3D virtual stage performance content in various forms.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A content playback apparatus for providing an interactive augmented space, comprising:
an augmented space recognition unit for reconfiguring a real space into a virtual space based on one depth image extracted from the real space, matching one or more primitive objects to the virtual space, and projecting one or more virtual 3D objects, mapped to the primitive objects and combined with the reconfigured virtual space, onto the real space; and
an interaction processing unit for recognizing one or more gesture interactions of a user related to the virtual 3D objects projected onto the real space and projecting the virtual 3D objects onto the real space by incorporating deformations of the virtual 3D objects resulting from the recognized gesture interactions.

2. The content playback apparatus as set forth in claim 1, wherein the augmented space recognition unit comprises an augmented space display multi-connection module for merging a plurality of depth images, extracted by a plurality of cameras installed in the real space, into the depth image.

3. The content playback apparatus as set forth in claim 1, wherein the augmented space recognition unit comprises a real space 3D recognition module for reconfiguring the depth image of the real space into the virtual space in a form of 3D polygons or point clouds.

4. The content playback apparatus as set forth in claim 1, wherein the augmented space recognition unit comprises a virtual space matching module for matching the primitive objects, included in content, to the reconfigured virtual space.

5. The content playback apparatus as set forth in claim 1, wherein the augmented space recognition unit comprises an augmented space content projection module for projecting the virtual 3D objects onto the real space.

6. The content playback apparatus as set forth in claim 1, wherein the interaction processing unit comprises a gesture interaction recognition module for generating interaction point information and gesture information by recognizing interaction points and one or more gestures of the user, placed in the real space, using multi-user information identified from the depth image of the real space.

7. The content playback apparatus as set forth in claim 1, wherein the interaction processing unit comprises an interactive augmented stage configuration module for reconfiguring the virtual 3D objects projected onto the real space by incorporating one or more user interactions based on interaction point information and gesture information generated by recognizing the user placed in the real space.

8. The content playback apparatus as set forth in claim 1, wherein the interaction processing unit comprises:
a user recognition/tracking module for generating multi-user information by identifying the user in the depth image of the real space; and
an interactive augmented stage configuration module for generating real space coordinate information and one or more gesture events of interaction points based on user gesture information and interaction point information.

9. The content playback apparatus as set forth in claim 1, further comprising an augmented space reconstruction unit for combining the virtual 3D objects with the primitive objects matched with the reconfigured virtual space and rendering the virtual 3D content, mapped to the reconfigured virtual space, among results combined with the reconfigured virtual space.

10. The content playback apparatus as set forth in claim 9, wherein the augmented space reconstruction unit comprises a content processing module for loading content in which a plurality of the primitive objects and a plurality of the virtual 3D objects have been paired and allocating the virtual 3D objects, included in the loaded content, to the primitive objects matched with the reconfigured virtual space.

11. The content playback apparatus as set forth in claim 9, wherein the augmented space reconstruction unit comprises a 3D new configuration reconstruction module for mapping the virtual 3D objects, included in the content, to the primitive objects matched with the reconfigured virtual space.

12. The content playback apparatus as set forth in claim 9, wherein the augmented space reconstruction unit comprises:
an augmented content playback module for combining the reconfigured virtual space, to which the virtual 3D objects have been mapped, with the real space by matching the reconfigured virtual space to the real space; and
a 3D rendering module for rendering virtual 3D content which is obtained by subtracting the reconfigured virtual space from the results combined with the real space by the augmented content playback module.

13. A content playback method for providing an interactive augmented space, comprising:
loading, by an augmented space reconstruction unit, content including one or more primitive objects and one or more virtual 3D objects;
matching, by an augmented space recognition unit, the primitive objects, included in the content, to a virtual space reconfigured based on one depth image of a real space;
mapping, by the augmented space recognition unit, the virtual 3D objects, included in the content, to the primitive objects matched with the reconfigured virtual space; and
projecting, by the augmented space recognition unit, the mapped virtual 3D objects onto the real space.

14. The content playback method as set forth in claim 13, wherein the matching comprises:
merging a plurality of depth images extracting from the real space;
reconfiguring the real space into the virtual space using the merged depth image;
detecting areas where the primitive objects included in the content will be placed in the reconfigured virtual space; and
matching the primitive objects to the detected areas.

15. The content playback method as set forth in claim 14, wherein the reconfiguring comprises reconfiguring the real space into the virtual space in a form of 3D polygons or point clouds.

16. The content playback method as set forth in claim 13, wherein the mapping comprises:
allocating the virtual 3D objects, included in the content, to the primitive objects matched with the reconfigured virtual space; and
mapping the allocated virtual 3D objects to the reconfigured virtual space.

17. The content playback method as set forth in claim 13, wherein the projecting comprises:
combining the virtual 3D objects with the reconfigured virtual space;
rendering the combined virtual 3D objects; and
projecting the rendered virtual 3D objects onto the real space.

18. The content playback method as set forth in claim 17, wherein the rendering comprises rendering only virtual 3D content among the primitive objects and the virtual 3D content combined with the reconfigured virtual space.

19. The content playback method as set forth in claim 13, further comprising incorporating, by an interaction processing unit, one or more user interactions in the real space into the projected virtual 3D objects.

20. The content playback method as set forth in claim 19, wherein the incorporating comprises:
identifying multi-user information in the real space;
recognizing one or more user gestures and interaction points based on the identified multi-user information;
generating one or more gesture events by matching the recognized user gesture and interaction points with the reconfigured virtual space via topological space matching; and
projecting the virtual 3D objects onto the real space by incorporating deformations of the virtual 3D objects based on the generated gesture events into the real space.
